(19) United States
(12) Patent Application Publication
(10) Pub. No.: US 2025/0148076 A1
(43) Pub. Date: May 8, 2025

(54) AUTOMATED SECURITY ANALYSIS AND RESPONSE OF CONTAINER ENVIRONMENTS

(71) Applicant: Cado Security Ltd., Altrincham (GB)

(72) Inventors: George Edward LEWIS, London (GB); Adam Cohen HILLEL, London (GB); Luke Irvine, London (GB); Paul SCOTT, London (GB)

(73) Assignee: Cado Security Ltd., Altrincham (GB)

(21) Appl. No.: 18/853,686

(22) PCT Filed: Apr. 4, 2023
(86) PCT No.: PCT/EP2023/058896

§ 371 Date: Oct. 2, 2024

Related U.S. Application Data
(60) Provisional application No. 63/327,318, filed on Apr. 4, 2022.

(51) Int. Cl. G06F 21/55

(52) U.S. Cl. CPC G06F 21/554; G06F 2221/034

(57) ABSTRACT

A computer security method for analyzing data sets for remediating security incidents in a cloud-based response system. Logs of data are retrieved from a computer network. The logs of data are parsed and filtered into the data sets. The logs of data are filtered by creating an event timeline of the computer network by identifying events from the data sets. An event timeline of the computer network is analyzed from the data sets to identify whether data from the logs of data is accessed by an unauthorized computing system. Based on a result of the identification of whether data from the logs of data is accessed by an unauthorized computing system, a set of suggested tasks, wherein each suggested task of the set of suggested tasks represents techniques for isolating a host connected to the computer network if the data has been compromised.

### CLAIM FOR PRIORITY

This application claims the benefit of and is a non-provisional of co-pending US (Provisional) application Ser. No. 63/327,318 filed on Apr. 4, 2022, which is hereby expressly incorporated by reference in its entirety for all purposes.

### BACKGROUND

This disclosure relates in general to security analysis of computer networks and, more particularly (although not necessarily exclusively), to using a scalable, cloud-based, computer architecture to identify if the computer network has been compromised by an attacker.

The size and complexity of computer networks are increasing at a rapid pace. However, with increased size and complexity, networks can also become more vulnerable to security incidents, such as network attacks by adversaries. It is imperative to identify if the computer networks have been compromised by an attacker and accordingly take appropriate steps so that information leaks from the computer networks can be prevented.

### SUMMARY

In one embodiment, the present disclosure provides a computer security method for analyzing data sets for remediating security incidents in a cloud-based response system. Logs of data are retrieved from a computer network. The logs of data are parsed and filtered into the data sets. The logs of data are filtered by creating an event timeline of the computer network by identifying events from the data sets. An event timeline of the computer network is analyzed from the data sets to identify whether data from the logs of data is accessed by an unauthorized computing system. Based on a result of the identification of whether data from the logs of data is accessed by an unauthorized computing system, a set of suggested tasks, wherein each suggested task of the set of suggested tasks represents techniques for isolating a host connected to the computer network if the data has been compromised.

In an embodiment, a computer security method for analyzing a plurality of data sets for remediating security incidents in a cloud-based response system. In one step, logs of data are retrieved from a computer network and the logs of data and filter the logs of data are parsed into a plurality of data sets. The logs of data are filtered by the data analysis system. An event timeline of the computer network is created. Known events based on malicious or suspicious indicators on the logs of data, key events linked to the same processes, users, files, network connections as events highlighted by the malicious or the suspicious indicators, and incident events with a time period matching the known events and the key events are identified. Primary events are identified from the known events, key events, and incident events. The event timeline of the computer network is analyzed from the plurality of data sets to identify whether data from the logs of data is accessed by an unauthorized computing system. The primary events are associated with the unauthorized computing system. Based on a result of the identification of whether data from the logs of data is accessed by an unauthorized computing system, a set of suggested tasks. Each suggested task of the set of suggested tasks represents techniques for isolating a host connected to the computer network if the data has been compromised.

In another embodiment, a cloud-based response system for analyzing data for remediating security incidents in a cloud environment. The cloud-based response system includes a data acquisition system configured to retrieve logs of data from a computer network and a data analysis system configured to parse the logs of data and filter the logs of data into a plurality of data sets. The logs of data are filtered by the data analysis system. An event timeline of the computer network is created. Known events based on malicious or suspicious indicators on the logs of data, key events linked to the same processes, users, files, network connections as events highlighted by the malicious or the suspicious indicators, and incident events with a time period matching the known events and the key events are identified. Primary events are identified from the known events, key events, and incident events. The event timeline of the computer network is analyzed from the plurality of data sets to identify whether data from the logs of data is accessed by an unauthorized computing system. The primary events are associated with the unauthorized computing system. The action recommendation system is configured to generate, based on a result of the identification of whether data from the logs of data is accessed by an unauthorized computing system, a set of suggested tasks. Each suggested task of the set of suggested tasks represents techniques for isolating a host connected to the computer network if the data has been compromised.

In yet another embodiment, a non-transitory computer-readable medium comprising instructions that are executable by a processing device for causing the processing device to perform operations comprising:
retrieving logs of data from a computer network;
parsing the logs of data and filtering the logs of data into one or more data sets, wherein the filtering of the logs of data includes:
creating an event timeline of the computer network;
identifying: known events based on malicious or suspicious indicators on the logs of data, key events linked to the same processes, users, files, network connections as events highlighted by the malicious or the suspicious indicators, incident events with a time period matching the known events and the key events, and primary events from the known events, key events, and incident events;
analyzing using a data analysis system, the event timeline of the computer network from the one or more data sets to identify whether data from the logs of data is accessed by an unauthorized computing system, wherein the primary events are associated with the unauthorized computing system; and
generating, based on a result of the identification of whether data from the logs of data is accessed by an unauthorized computing system, a set of suggested tasks, wherein each suggested task of the set of suggested tasks represents techniques for isolating a host connected to the computer network if the data has been compromised.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of an example of a specialized computer architecture configured to perform data analysis of computing systems;

FIG. 2 illustrates a block diagram of another example of a specialized computer architecture configured to perform data analysis of computing systems;

FIG. 3 illustrates a flowchart illustrating a process flow for data acquisition used in medium-depth process;

FIG. 4 illustrates a block diagram of the data analysis system;

FIG. 5 illustrates a block diagram of a recommendation engine of a data analysis system;

FIG. 6 illustrates a process flow for data acquisition used in heavy-depth process;

FIG. 7 illustrates a process flow for data acquisition used in light-depth process;

FIG. 8 illustrates a process for performing a security analysis of a computer network;

FIG. 9 illustrates a flowchart of a data analysis process for identifying and remediating security incidents in a cloud-based response system;

FIG. 10 illustrates a flowchart of a resiliency score determining process for overcoming incidents in cloud environments; and

FIG. 11 illustrates a flowchart of a data sufficiency determining process for overcoming incidents in cloud environments.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Certain aspects and examples of the present disclosure relate to performing an analysis of containerized machines, such as Amazon Fargate™/Amazon ECS™, to identify if they have been compromised by an attacker. If they are compromised, then automatically isolate a host to prevent further damage. For example, a network can include one or more on-premises networks, cloud networks, or containerized systems that have been the subject of a security incident. A security incident can occur when an adversary (e.g., human or automated) exploits a security vulnerability of the network.

The process of the present disclosure can be divided into three steps. Step one can include retrieving data to a response server from the containerized machine (for example cloud networks). From the data thus retrieved, signs of compromise can be analyzed (step two). If signs of compromise are found, the machine can be isolated (step three).

The acquisition of data for analysis can be performed either using a middle-depth process, heavy-depth process, or light-depth process. In the middle-depth process, the AWS execute-command (based on the Systems Manager Agent (SSM Agent)) is leveraged to get an interactive session on the container. A response platform generates, and using the interactive session, also runs Command Line Interface (CLI) command that download and executes the host tool in the container. The host process runs and collects interesting files from the filesystem and then uploads the result to an S3 bucket, using a pre-signed Uniform Resource Locator (URL) given to it by the response platform (the Command Line Interface (CLI) command). The response platform monitors S3 buckets for new acquisition uploads, which then finds the latest one uploaded by the host that ran in the container. When a new upload is detected, the response platform starts to process it with our processing engine.

The heavy-depth process acquires a full copy of the container disk. This takes a bit long and provides access to all files. In the heavy-depth process, firstly a user generates a host script for the user specified Operating System (OS). The host is downloaded (if not on a local machine) and run by the target machine. The target machine disk is opened and reads raw in chunks. A chunk is zipped and uploaded to the S3 bucket (using S3 pre-signed URLs), one chunk at a time. Once a full disk is chunked, zipped, and uploaded to S3. The response platform determines that the job is finished and combines all the chunks back into one single raw binary file (disk image). The disk image is then processed by the response platform.

In a light-depth process, volatile acquisition of data is used. The volatile acquisition method is the quickest option for acquiring data and data that will other be destroyed (volatile data). In the light-depth process, a user provides a list of containers to collect from any of AWS ECS, AWS EKS, or Azure AKS. The Cloud Service Provider (CSP) Application Programming Interface (API)'s used. Using the CSP APIs, open an interactive console session to either the container (for ECS) or the Kubernetes pod (for EKS & AKS). Collect volatile data from the/proc virtual Linux directory using the cat & ls commands and parse their output into a format easily read by other systems (JSON). Present or write to file the volatile data organized by cluster, then task/deployment, then container.

If it is determined that the computer network has been compromised, appropriate actions are performed. For example, several isolation and remediation steps can be performed depending on settings, including, but not limited to, disconnecting the container from the network and keep running, turning the container off, disabling security credentials associated with the container, acquiring data for any system the container may have touched, and re-starting the overall process for that second container.

Illustrative examples are given to introduce the reader to the general subject matter discussed herein and are not intended to limit the scope of the disclosed concepts. The following sections describe various additional features and examples with reference to the drawings in which numerals indicate elements and directional descriptions are used to describe the illustrative aspects, like the illustrative aspects, should not be used to limit the present disclosure.

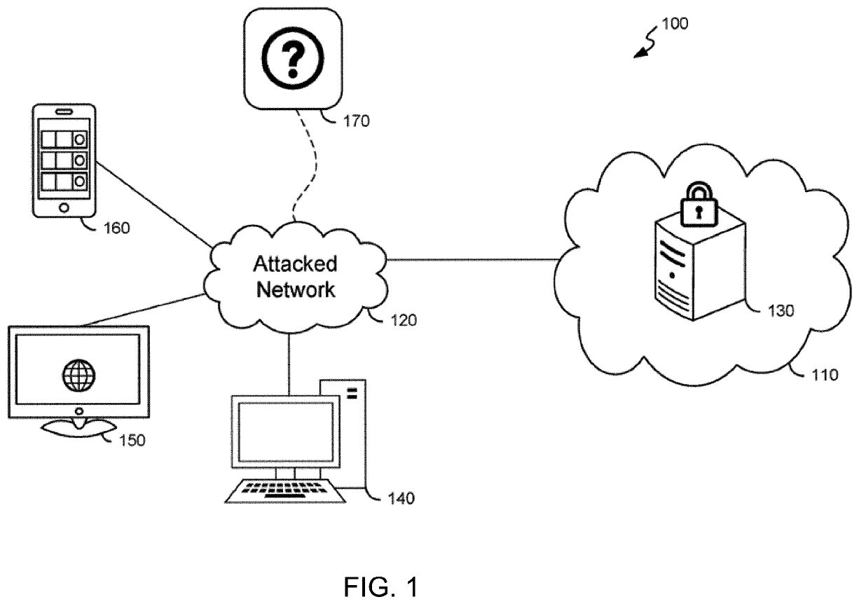

Referring to the FIG. 1, a block diagram of an example of a scalable cloud-computing system architecture configured to perform security analysis of computer networks, according to some aspects of the present disclosure is shown. Network environment 100 can include cloud network 110 and attacked network 120. The cloud network 110 can be any set of servers and databases associated with a cloud network. Further, the cloud network 110 can include a cloud-based response system 130, which may be the specialized computer architecture configured to acquire data for analysis from the attacked network 120, processing the data to identify if the data has been compromised by an attacker and if the data has been compromised, apply isolation and mediation techniques. Further, the cloud-based response system 130 can include one or more networks (for example, public network or private network) that include one or more servers and one or more databases. One or more servers can be configured to execute source code that, when executed, performs data acquisition techniques for analysis, as described in various implementations herein.

The attacked network 120 can be any one or more on-premises networks, cloud networks, containerized systems, or any combination thereof. Further, the attacked network 120 may include at least one computing device that was the subject of a security incident. A security incident can occur when an adversary, for example, human or automated exploits a security vulnerability of the network. As an illustrative example, a security incident may be a computing device that makes unauthorized changes to one or more files stored in a database.

Each of the cloud-based response system 130 and the attacked network 120 can include any open network, such as the Internet, personal area network, local area network (LAN), campus area network (CAN), metropolitan area network (MAN), wide area network (WAN), wireless local area network (WLAN); and/or a private network, such as an intranet, extranet, or other backbones. In some implementations, the attacked network 120 and the cloud-based response system 130 can digitally communicate with each other using any digital link for example, wired or wireless, such as a Bluetooth or Bluetooth Low Energy channel.

In some implementations, communications between two or more systems and/or devices included in the network environment 100 can be achieved by a secure communications protocol, such as a secure sockets layer (SSL), and transport layer security (TLS). In addition, data and/or transactional details may be encrypted based on any convenient, known, or to be developed manner, such as, but not limited to, DES, Triple DES, RSA, Blowfish, Advanced Encryption Standard (AES), CAST-128, CAST-256, Decorrelated Fast Cipher (DFC), Tiny Encryption Algorithm (TEA), extended TEA (XTEA), Corrected Block TEA (XXTEA), and/or RC5, etc.

The attacked network 120 can be connected to a computer 140, a smart TV 150, and a mobile device 160. The attacked network 120 can be any on-premises, cloud, or containerized system, for example, one that is operated by or for an enterprise. A network host 170 can be any network entity, such as a user, a device, a component of a device, or any other suitable computing device connected to a computer network, such as the attacked network 120. The network host 170 can execute a network attack on the attacked network 120 as an unauthorized network host, such as a human or automated hacker, a computer virus, or other malicious code. The network host 170 can access secured servers or databases included within the attacked network 120 to collect, delete, or modify data (e.g., secured files) in an unauthorized manner. The network host 170 can access the secured servers or databases in an unauthorized manner due to a security vulnerability in the attacked network 120, such as a weak password entailed to access the attacked network 120. Either substantially in real-time or non-real-time, the network host 170 can access certain data stored within the attacked network 120 in an authorized manner (for example, a website that allowed access after a cookie has been installed in a browser) or an unauthorized manner (for example, attacked network 120 may be hacked by the network host 170). Either way, the network host 170 can evaluate the collected data or can modify existing data stored in the attacked network 120. According to certain implementations described herein, the cloud-based response system 130 can be used to acquire data that may provide details on the network host 170 and the attacked network 120, process the data to identify if the data has been compromised, and suggest prevention techniques if the data has been compromised.

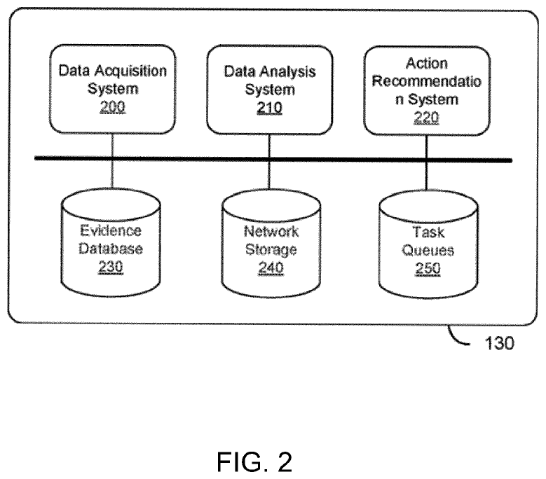

FIG. 2 is a block diagram of another example of a specialized computer architecture configured to perform security analysis of computer networks, according to some aspects of the present disclosure. The cloud-based response system 130 can be a cloud-computing network that includes a data acquisition system 200, a data analysis system 210, and an action recommendation system 220. Each of the data acquisition system 200, the data analysis system 210, and the action recommendation system 220 can include one or more processors and memory storing executable code that, when executed by the one or more processors, performs functionality described herein.

The data acquisition system 200 can be configured to perform data acquisition from the attacked network 120. For example, the data acquisition system 200 can collect a copy of each computer, server, host, or other systems that accessed the attacked network 120. Further, the data acquisition system 200 can perform the data acquisition regardless of whether the attacked network 120 is a cloud network (e.g., Amazon Web Services (AWS) Elastic Compute Cloud (EC2)™, Azure™), local on-premises network, or containerized system (e.g., Docker™, Kubernetes™, OpenShift™, AWS Fargate™, AWS Lambda™), or any combination thereof. The data acquisition system 200 can acquire the data from the attacked network 120 in a manner that maintains a full chain of custody. For example, the data can include a log capturing which hosts accessed a server and a time stamp associated with each instance that a host accessed a server. The data acquisition system 200 can also generate a hash of the acquired data and store that hash. The data acquired by the data acquisition system 200 can be stored in the evidence database 230.

In some implementations, the data acquisition system 200 can acquire data from the attacked network 120 using the Application Programming Interfaces (APIs) of a cloud provider to copy disks attached to a target system or network. The data acquisition system 200 can then create a new machine configured to attach the disks of the target system or network to the new machine. The data acquisition system 200 can configure the new machine to match the size of the target system or network in terms of the same number of Central Processing Units (CPU)s, Random Access Memory (RAM), and so on. The data acquisition system 200 can turn the new machine off as the disks of the target system or network are attached to avoid potential errors. The data acquisition system 200 can also be configured to directly copy the target disks to cloud storage. The data acquisition system 200 can compress the data collected from the attacked network 120 as the data is uploaded to the cloud storage and perform a cryptographic hash of the copied disk to create a Chain of Custody that ensures the disk image is a true copy of the original disk.

The data can be acquired for analysis using any of the three processes-medium-depth processes, heavy-depth process, and light-depth process. The “heavy-depth” process acquires a full copy of the container disk. This takes longer and provides access to all files. The light-depth process is also called the volatile acquisition method. The volatile acquisition method is the quickest option for acquiring data and acquiring data that will other be destroyed (volatile data).

The data analysis system 210 can be configured to process the data to detect malicious activity for identifying if a security incident has occurred in the attacked network 120. In some implementations, processing the data can include parsing logs and file content included in the data to detect malicious activity. Processing the data can also include unifying and matching different data sources. A network storage 240 can store, for example, the source code and evidence files accessed by the workers or the cloud-based response system 130. As an illustrative example, the network host 170 accessed an on-premises network in an unauthorized manner (e.g., through a security vulnerability, such as an unrestricted ability to upload files, which may contain malware). While the unauthorized network host 170 was connected to the on-premises network, the network host 170 accessed ten different machines within the network. Each of the ten machines captured a log of any communications with the network host 170. The data analysis system 210 can automatically match the logs across the ten different machines to identify a sequence of events performed by the unauthorized network host 170. The data analysis system 210 can match logs based on any attribute within the logs, such as username or IP address. Additionally, even if one or more of the logs had a different structure (e.g., different order of data fields), or even if one or more logs used a different naming protocol to uniquely identify communication with the unauthorized network host 170, the data analysis system 210 can perform fuzzy matching techniques to match the logs together to determine the sequence of events performed by the unauthorized network host 170. As an illustrative example, the data analysis system 210 can detect and extract the name of network hosts from logs, regardless of the exact structure of the log format. The data analysis system 210 can execute logic to fuzzy match the extracted names of network hosts, for example, by removing the network domain from systems. If, for example, the data analysis system 210 detects a connection from PC-XYZ in one log, and a connection from PC-XYZ.example.com in another log, the data analysis system 210 can still identify these two logs as connections from the same system using the fuzzy matching techniques.

In some implementations, the data analysis system 210 can process the data using a scalable processing technique. The data analysis system 210 can evaluate the data to generate a set of tasks that need to be performed as part of processing the data. The data analysis system 210 can be configured to execute logic that selects a subset of tasks from a set of available tasks to process the data. The subset of tasks can be selected based on the data acquired from the attacked network 120. Non-limiting and non-exhaustive examples of tasks are shown in Table 1 below.

TABLE 1

| Task Identifier | Task Explanation |
|---|---|
| Cloud_Acquire | Copy a system to a storage service (e.g., |
| | Amazon S3 ™) |
| Cloud_Downloader | Download a system from a storage service |
| Decompress_And_Mount | Decompress (e.g., .GZ) and mount file |
| | systems (e.g., XFS) |
| Timeline_Files | Build a timeline of file creation events |
| | before or after the security incident was |
| | detected |
| Extract_Files | Extract files from a file system for later |
| | processing |
| Parse_Custom_Timelines | Parse custom types of events |
| Disk_Info | Record disk size |
| Hash | Hash all files on the disk |
| Malware_Scans | Run scans using a library (e.g., Yara) |
| Timeline_Files | Parse logs and system data using a timeline |
| | library |
| Strings | Extract and index strings from all files |
| Detect_PII | Detect personally-identifiable information |
| | using machine-learning models, such as a |
| | Bayes model |
| Hash_Disk | Hash the disk image |
| Create_Alerts | Run detection rules that match parsed logs |
| | and text |
| Intel | Run intelligence service lookups against |
| | detected files |
| IOC_Extract | Match malicious domains etc. based on the |
| | contents of files |
| Detach | Unmount any disk images still mounted |

The data analysis system 210 can determine the number of workers to generate to process the tasks, and then execute each worker in parallel to process the tasks. When a worker completes a task, then the worker can access the queue of tasks, retrieve the next task in the queue, and then process the retrieved task. For example, the tasks can be stored in task queue 250. Workers retrieve and process tasks in parallel until all of the tasks in the queue have been processed and completed. When all of the tasks have been processed, the workers automatically terminate, thereby making available the processing resources (e.g., vCPU and memory) for other purposes, such as for processing the data associated with a different security incident. The data analysis system 210 improves the functioning of servers in a cloud network because fewer computing resources are used for processing the tasks (e.g., due to the workers automatically terminating after the tasks are all processed) and the tasks are processed faster (e.g., due to the tasks being processed by workers in parallel and scaled to match the processing load associated with the set of tasks). In some implementations, the data analysis system 210 can evaluate each task to determine the number of workers to generate. For example, a given task may need to be processed by two workers, whereas a different task may only need to be processed by one worker. The number of workers to process per task can be determined or configured automatically (e.g., using a trained machine-learning model) or by a client (e.g., an entity associated with an investigator operating the cloud-based response system 130 to analyze a security incident). As an illustrative example, the data analysis system 210 can evaluate the data and, in response to the evaluation, generate 300 tasks. The 300 tasks can be stored in a queue. The data analysis system 210 can evaluate the 300 tasks and, in response to the evaluation, generate 100 workers. Each worker can retrieve a task from the queue and process the task against the data available to the worker. Further, the 100 workers process the 300 tasks from the queue in parallel. When a worker completes one task, that worker evaluates the queue to determine whether another task is available to process. After the 300 tasks have been processed, the 100 workers are automatically terminated, thus freeing up compute resources.

The action recommendation system 220 can be configured to generate a workflow of suggested tasks to guide a user through the security incident response under investigation. The action recommendation system 220 can select operations (for the workflow) that are contextual to the attributes of the security incident under investigation. As an illustrative example, the action recommendation system 220 can evaluate the evidence to identify that the network was attacked via a phishing email used to gain access to the network. In response, the user-assisted workflow system 220 can generate a workflow of suggested actions or tasks for the user to initiate as part of processing the acquired data to identify malicious activity that occurred after the breach of the network. For example, a suggested task can be to run a particular scan of the data to identify malicious data within the network.

In some implementations, the action recommendation system 220 can be configured to automatically recommend actions (e.g., investigative and remediation actions) for the user to perform (e.g., based on predefined rules). The recommended actions can include disconnecting the host from the network while keeping the host running or turning off the host completely, disabling the security credentials associated with the host, acquiring data for any system the host may have touched, and re-starting the overall process for that second host.

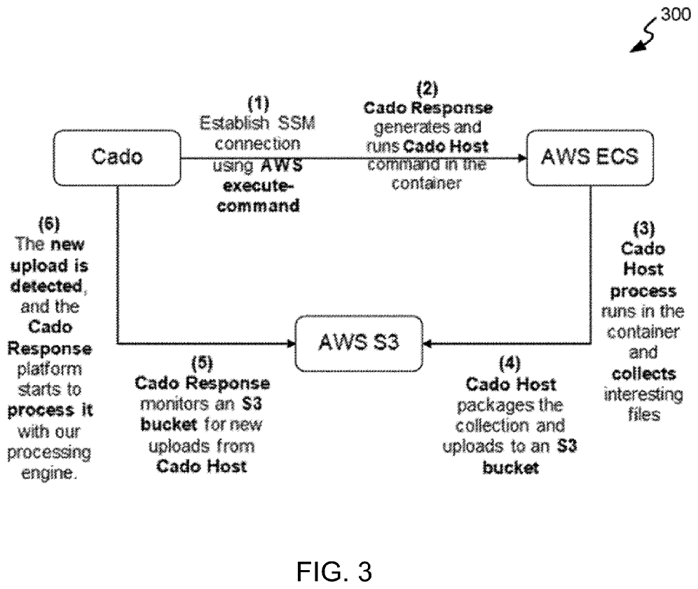

Referring to FIG. 3 now, a process of data acquisition used in a medium-depth process is described. At block 302, an SSM connection is established using the AWS execute-command. This includes leveraging the AWS execute-command (based on an SSM Agent) to get an interactive session on a container. At block 304, a cloud-based response system 130 generates and runs a host command in the container. In more detail, the response platform generates, and using the interactive session also runs a CLI command that downloads and executes the host tool in the container. At block 306, the host process runs in the container and collects interesting files. At block 308, the host packages the collection and uploads it to an S3 bucket. In this, the result obtained from the block 306 is uploaded to the S3 bucket using a pre-signed URL given to it by the response platform (the CLI command). At block 310, the response monitors the S3 bucket for new uploads from the host. In this, the response platform monitors S3 buckets for new acquisition uploads, which it then finds the latest one uploaded by the host that ran in the container. At last, at block 312, when the new uploads are detected, the response platform starts to process it using the data analysis system 210.

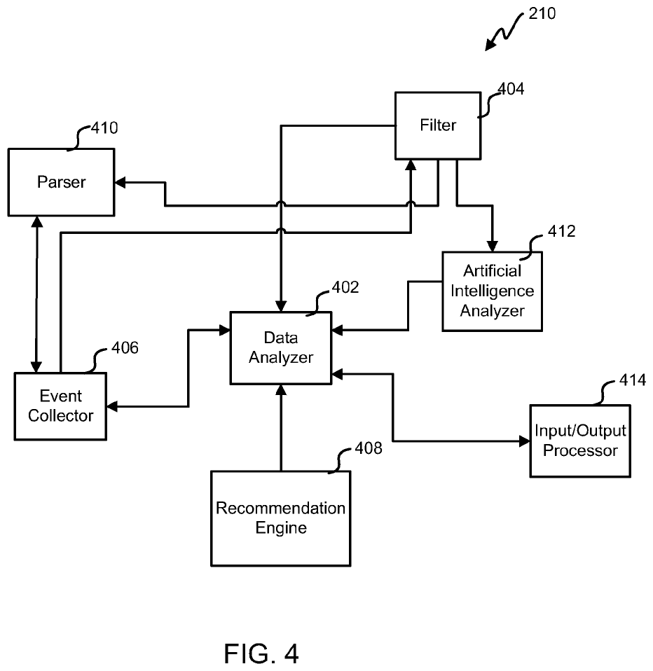

Referring to FIG. 4 now, a block diagram of the data analysis system 210 is shown. The data analysis system 210 is configured to receive logs of data from computer systems acquired by the data acquisition system 200 to perform data analysis, identify potential threats in the computer systems, and suggest remediated actions. The logs of data are acquired from one or more computer systems in a computer network over a period of time by the data acquisition system 200. The data analysis system 210 includes a data analyzer 402, a filter 404, an event collector 406, a recommendation engine 408, a parser 410, an artificial intelligence (AI) analyzer 412, and an input/output (I/O) processor 414.

The data analyzer 402 controls the functioning of the various components of the data analysis system 210. The data analyzer 402 also controls the flow of data to/from the I/O processor 414 into the data analysis system 210.

The I/O processor 414 receives the logs of data from the data acquisition system 200. The I/O processor 414 provides an interface with the other components such as the data acquisition system 200, the action recommendation system 220, the evidence database 230, the network storage 240, and the task queues 250. The I/O processor 414 provides results from the recommendation engine 408 for display on a display device (not shown) of a user of the computing system.

The parser 410 breaks the logs of data into data sets for event identification by the event collector 406, filtration by the filter 404, and further analysis of the filtered data sets by the AI analyzer 412. The parser 410 provides the parsed logs of data to the event collector 406.

The event collector 406 uses AI/machine learning algorithms and/or fuzzy logic to identify events from the logs of data. The event collector 406 creates an event timeline of the computer network. The event timeline is created by identifying events from the logs of data of the computer system. The event collector 406 identifies known events, key events, and incident events. The known events are based on malicious or suspicious indicators on the logs of data, the key events are linked to the same processes, users, files, network connections of events highlighted by the malicious or suspicious indicators. The incident events are events with a time period matching or in proximity to the known events and the key events. The event collector 406 provides the known events, the key events, and the incident events to the filter 404.

The filter 404 includes machine learning algorithms that identify primary events from the known events, the key events, and the incident events. The primary events are the most interesting events that relate to malicious or suspicious activity or an unauthorized access to computer systems. The primary events are provided to the artificial intelligence analyzer 412 for further processing.

The artificial intelligence analyzer 412 includes machine learning and AI models that process the primary events from the filter 404 to identify risks from the primary events such as the malicious attack, a virus, the suspicious activity, and/or the unauthorized access to the computer system. The determination of whether the computer system and/or the computer network has been accessed by the unauthorized computing system includes the computing system modifying, deleting, and/or acquiring data to the network without authorization. The machine learning and AI models are trained on various types of events including the primary events, the known events, the key events, and the incident events. The models can identify the types and severity of the risks from the primary events and indicate to the data analyzer 402. The data analyzer 402 further provides the risks and the severity to the recommendation engine 408 for processing.

The recommendation engine 408 suggests a set of remediated actions, for example, a set of suggested tasks to the user on the display device. The suggested tasks include isolating the host connected to the computer system, installing an anti-virus, disconnecting the computer system, and/or other remediations in response to the risks. The suggested tasks may be determined based on a preset set of rules or machine learning algorithms or predefined by the user. The suggested tasks are displayed to the user on the display device via the I/O processor 414. The set of suggested tasks includes executing a wizard, evaluating an enrichment to one or more log events, or managing a task using an auto-suggest technique.

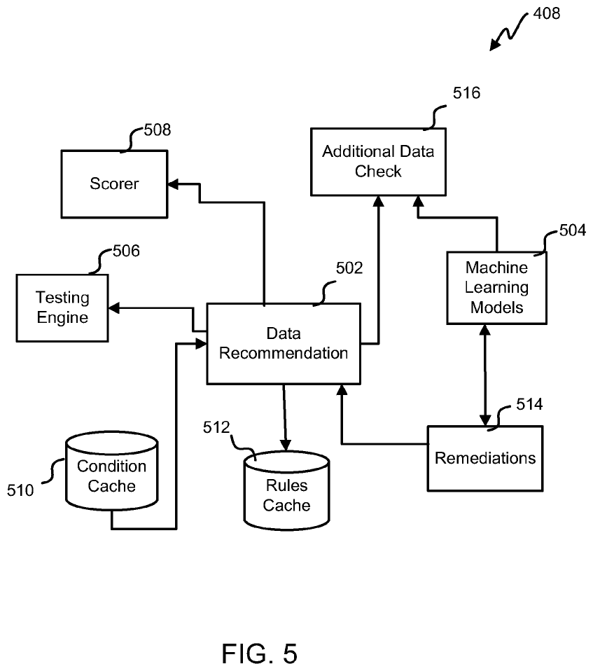

Referring to FIG. 5 now, a block diagram of the recommendation engine 408 of the data analysis system 210 is shown. The recommendation engine 408 is configured to provide a resiliency score, and remediations. The recommendation engine 408 provides the resiliency score and the remediations to the action recommendation system 220. The recommendation engine 408 includes a data recommendation 502, machine learning models 504, a testing engine 506, a scorer 508, a condition cache 510, a rules cache 512, remediations 514, and an additional data check 516.

The primary events are presented with a signal that can indicate a vulnerability associated with a computing system of the computer network, a prediction associated with the vulnerability, and a remediation for the vulnerability. The signal is generated using natural language processing by the machine learning models 504. The recommendations include predefined tasks including installing an anti-virus, disconnecting the computer system, and/or other remediations in response to the risks.

The data recommendation 502 identifies a cloud environment of a plurality of cloud environments associated with the computer network. The cloud environment includes the user device or the computer system. The data recommendation 502 identifies the cloud environment by identifying a cloud provider, a location, types of systems, several systems, objective, and/or identification methods of the cloud environment.

The data recommendation 502 identifies one or more conditions from the condition cache 510 for the identification of the cloud environment. The conditions are associated with incidents or risks in the cloud environment and its computer systems. The conditions are stored in the condition cache 510 by the network operator or an enterprise. The data recommendation 502 further identifies rules corresponding to the conditions from the rules cache 512. The rules include remediated actions including an alert, a severity indication, and/or remediations based on the conditions. The rules are actions that should be initiated when certain conditions occur in the cloud environment. For example, a threat, a malicious activity, an unauthorized access may have occurred, under these conditions the rules define that the affected computer system should be isolated from the other systems in the computer network. The rules selected from the rules cache 512 correspond to the conditions identified from the condition cache 510. The rules are applied by the data recommendation 502 on the cloud environment and indicated to the testing engine 506 for verification of its application.

The testing engine 506 executes tests on the cloud environment in order to check the application of the rules on the cloud environment. The tests verify that telemetry is available, accesses set up successfully, and actions are executed successfully on the cloud environment. The testing engine 506 verifies the rules and verifies the data recommendation 502 and the scorer 508.

The scorer 508 determines a resiliency score of the cloud environment that indicates a resiliency of the cloud environment when certain conditions have occurred. For example, the resiliency to overcome malicious attacks or suspicious activities in the cloud environment. The resiliency score is determined based on the tests on the cloud environment. The resiliency score determines the success rate of the rules responding to an incident based on results of the test when certain conditions have occurred and a characteristic of the cloud environment that includes size and/or criticality of the cloud environment. The resiliency score is a numerical score on a scale of 1-10 with 1 indicating the least probability to overcome attacks under the conditions and 10 being the highest probability to overcome attacks under the conditions. The resiliency score is provided to the action recommendation system 220 to display the score to the user(s) of the cloud environment. For example, a resiliency score of 8 indicates the cloud environment is good to overcome risks whereas a resiliency score of 3 indicates the cloud environment is susceptible to the risks.

The additional data check 516 identifies whether the data acquired by the data acquisition system 200 is sufficient for the data analysis system 210 and whether additional data is entailed or not. The data is analyzed by the data recommendation based on the plurality of rules. The data is analyzed to identify a compromised system of the cloud environments in the cloud network. The additional data check 516 uses results of the analyzed data and the characteristics of the cloud environment to determine additional data for analysis. The additional data is determined by verifying that similar workloads are not compromised, gathering first data from systems that the compromised system is connected to, capturing second data from the systems, and gathering third data from systems running in the same user/role context as the compromised system. Based on the verifying, acquiring the additional data for the compromised system. The additional data is provided to the data acquisition system 200 via the I/O processor 414 to capture additional data from the computer systems of the cloud environment in the computer network.

The machine learning models 504 processes the risks identified from the data analysis system 210 and the primary events from the logs of data using natural language processing. The result of the natural language processing is displayed on the user interface of the user. For example, computer system XX has been unauthorizedly accessed at 3 pm from an unauthorized system, requiring it to be isolated. Further, the additional data needed as indicated by the additional data check 516 is also processed using the natural language processing and provided to the data acquisition system 200. For example, more data on unauthorized systems and their logs are needed.

The remediations 514 include remediated actions for overcoming the risks associated with the compromised system in the cloud environment of the computer network. The remediations include installing an anti-virus, isolating the compromised system, and deleting/modifying files with the risks. The remediations 514 are provided in the form of suggested tasks to the action remediation system 220 which applies the remediations on the compromised system. The suggested tasks from the remediations 514 are represented in the form of natural language that is easily understood by the user.

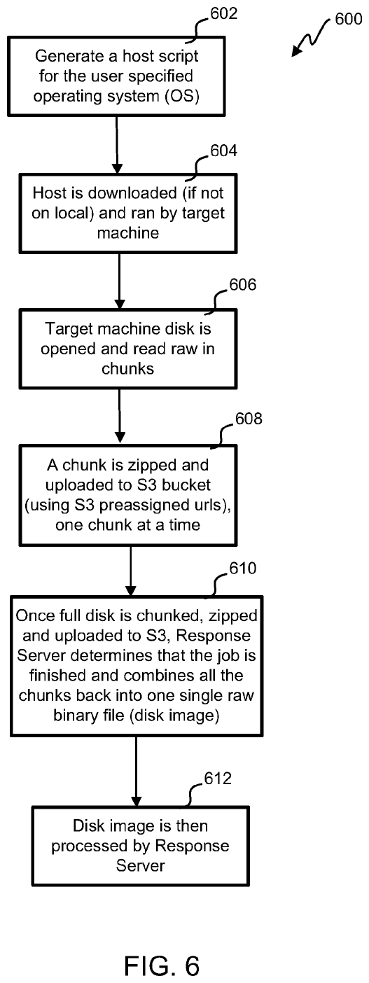

Referring to FIG. 6 now, a process flow 600 describing data acquisition in a heavy-depth process is described. As explained above, the heavy-depth process acquires a full copy of the container disk. At block 602, the user generates a host script for the user-specified operating system (OS). At block 604, the host is downloaded (if not on a local machine) and run by a target machine. At block 606, the target machine disk is opened and read raw in chunks. At block 608, a chunk is zipped and uploaded to S3 bucket (using S3 preassigned URLs), one chunk at a time. Once the full disk is chunked, zipped, and uploaded to S3, the cloud-based response system 130 determines that the job is finished and combines all the chunks back into one single raw binary file (disk image) (at block 610). At block 612, the disk image is then processed by the cloud-based response system.

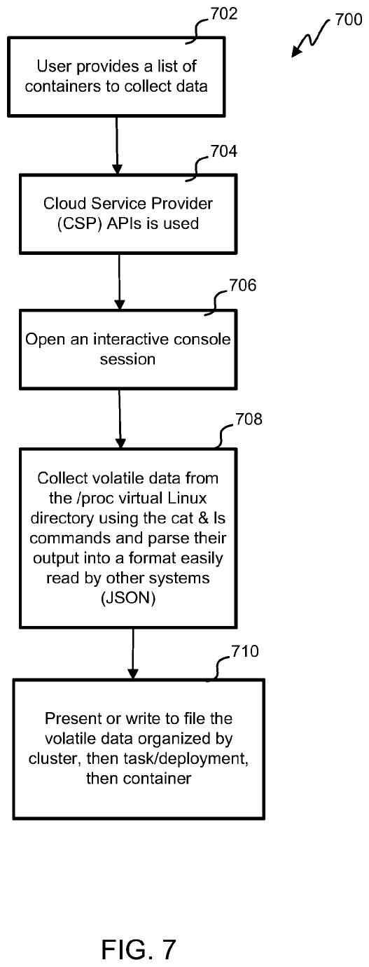

Referring to FIG. 7 now, a process flow 700 describing data acquisition in light-depth process is described. At block 702, a user provides a list of containers to collect from any of AWS ECS, AWS EKS, or Azure AKS. At block 704, the Cloud Service Provider (CSP) API is used. At block 706, using the CSP APIs, open an interactive console session to either the container (for ECS) or the Kubernetes pod (for EKS & AKS). At block 708, collect volatile data from the/proc virtual Linux directory using the cat & ls commands and parse their output into a format easily read by other systems (JSON). At block 710, present or write to file the volatile data organized by cluster, then task/deployment, then container.

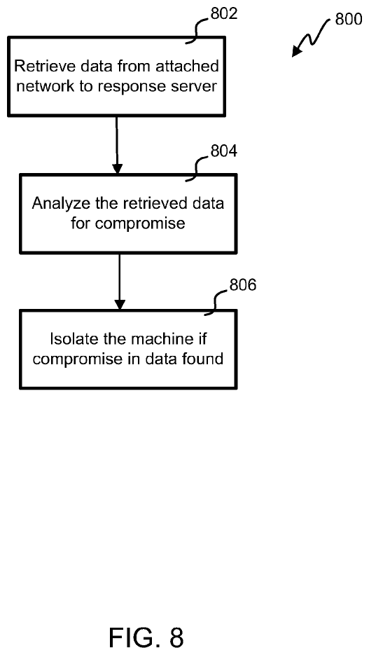

Referring to FIG. 8 now, flowchart 800 illustrates a process for performing security analysis of computer networks. At block 802, data is retrieved from one or more hosts by the cloud-based response system 130. At block 804, the data retrieved from the hosts is analyzed to identify if the data has been compromised. The compromise of the data will detect malicious activity that caused the security incident in the attacked network 120. If it has been detected that malicious activity has occurred, i.e., if the data has been compromised, one or more actions are recommended for isolating the attached network/host. (at block 806).

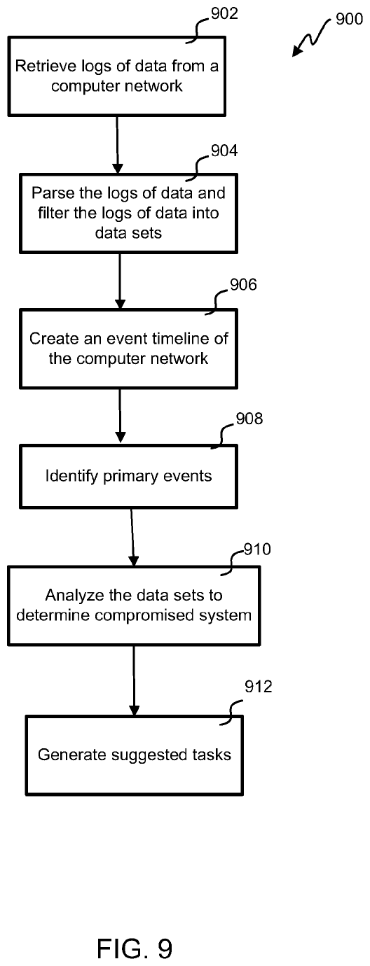

Referring next to FIG. 9, a flowchart of a data analysis process 900 or a computer security method for identifying and remediating security incidents in a cloud-based response system 130 is shown. The data analysis process 900 starts at block 902, where logs of data from computer systems and their corresponding cloud environments in the computer network are retrieved by the data analysis system 210 from the data acquisition system 200. At block 904, the logs of data are parsed into data sets and filtered to identify known events, key events, and incident events from the logs of data. At block 906, an event timeline for each of the computer systems in the computer network is created. The event timeline includes a log of events that occurred over a period of time.

At block 908, identify primary events from the known events, the key events, and the incident events from the filtered data sets of the logs of data. The primary events are the most interesting events for incidents and risks on the computer systems. The primary events are identified using machine learning models by matching suspicious activities and their sources to identify malicious systems.

At block 910, the data sets corresponding to the primary events are analyzed to identify the compromised computer systems. The malicious activities, suspicious behavior, and unauthorized access to the compromised computer systems are identified by matching the logs together to determine the sequence of events performed by the unauthorized network host 170. For example, detect and extract the name of the network hosts from logs, regardless of the exact structure of the log format. The data analysis system 210 can execute logic to fuzzy match the extracted names of network hosts, for example, by removing the network domain from systems. If, for example, the data analysis system 210 detects a connection from PC-ABC in one log, and a connection from PC-ABC.example.com in another log, the data analysis system 210 can still identify these two logs as connections from the same system using the fuzzy matching techniques.

At block 912, based on the identification of the suspicious activity from the compromised computer system, the action recommendation system 220 identifies remediations for the compromised system for example, isolating the compromised system, deleting affected files, and/or using updated anti-virus.

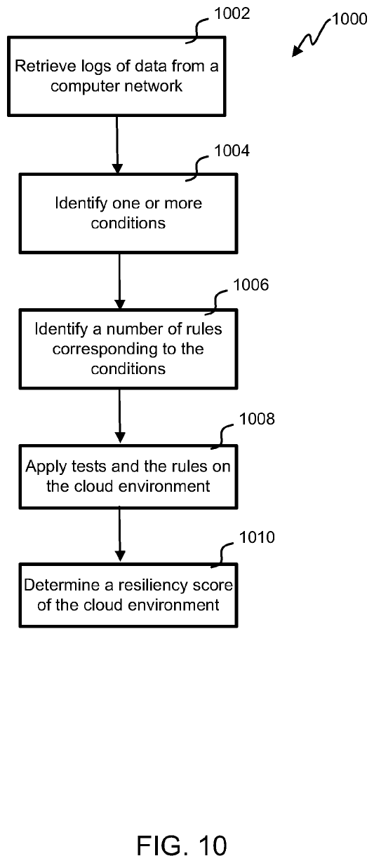

Referring next to FIG. 10, a flowchart of a resiliency score determining process 1000 or an incident analysis method for overcoming incidents in cloud environments is shown. The resiliency score determining process 1000 begins at block 1002 where the logs of data are retrieved from the computer systems of the computer network. The computer systems are in a plurality of cloud environments. The cloud environment is determined by identifying: a cloud provider, a location, types of systems, a number of systems, objective, and/or identification methods of the cloud environment.

At block 1004, one or more conditions are identified. The conditions are related to suspicious or malicious activities and unauthorized behaviour on the computer systems.

At block 1006, a number of rules corresponding to the conditions are identified for the cloud environment. The rules include remediations when certain conditions occur. The remediations include remediated actions including an alert, a severity indication, and/or remediations based on the conditions.

At block 1008, tests are executed, and the identified rules are applied to the cloud environment based on the cloud environment.

At block 1010, a resiliency score of the cloud environment is identified based on the tests on the cloud environment. The resiliency score determines the success rate of the rules responding to an incident based on the results of the test and characteristics of the cloud environment that includes size and/or criticality of the cloud environment.

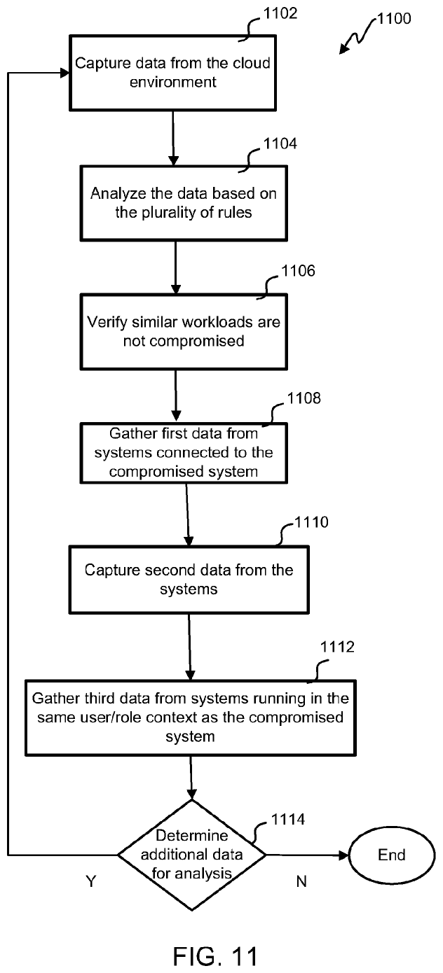

Referring next to FIG. 11, a flowchart of a data sufficiency determining process 1100 for overcoming incidents in cloud environments is shown. The data sufficiency determining process 1100 begins at block 1102, where data is captured from a cloud environment in the computer network by the data acquisition system 200. At block 1104, the data is analysed by a plurality of rules based on the occurrence of one or more conditions. The data analysis system 210 analyses the data. The conditions relate to threats and risks in the cloud environment. The rules include remediations like isolation of compromised systems and protection from risks on the computer systems of the cloud environment.

At block 1106, determinations are made to check whether the data analysed by the data analysis system 210. It is determined whether similar workloads in the cloud environment are not compromised.

At block 1108, first data is gathered from systems that the compromised system is connected to and verified.

At block 1110, second data from the systems is gathered and verified.

At block 1112, third data from systems running in the same user/role context as the compromised system is gathered.

At block 1114, based on the gathered first data, the second data, and the third data, a determination is made whether the data along with the first data, the second data, and the third data are sufficient for analysis. If additional data is not needed, the process 1100 ends else the additional data is captured by the data acquisition system 200 at 1102.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

1. A computer security method for analyzing a plurality of data sets for remediating security incidents in a cloud-based response system, the computer security method comprises:
retrieving logs of data from a computer network;
parsing the logs of data and filtering the logs of data into the plurality of data sets, wherein the filtering of the logs of data includes:
creating an event timeline of the computer network by;
identifying:
known events based on malicious or suspicious indicators on the logs of data,
key events linked to same processes, users, files, network connections of events highlighted by the malicious or the suspicious indicators,
incident events with a time period matching the known events and the key events, and
primary events from the known events, key events, and incident events;
analyzing using a data analysis system, the event timeline of the computer network from the plurality of data sets to identify whether data from the logs of data is accessed by an unauthorized computing system, wherein the primary events are associated with the unauthorized computing system; and
generating, based on a result of the identification of whether the data from the logs of data is accessed by the unauthorized computing system, a set of suggested tasks, wherein each suggested task of the set of suggested tasks represents techniques for isolating a host connected to the computer network if the data has been compromised.

2. The computer security method for analyzing a plurality of data sets for remediating security incidents in a cloud-based response system as recited in claim 1, further comprises presenting the set of suggested tasks on a user interface.

3. The computer security method for analyzing a plurality of data sets for remediating security incidents in a cloud-based response system as recited in claim 1, wherein identifying if the network has been accessed by the unauthorized computing system includes the computing system modifying, deleting and/or acquiring data to the network without authorization.

4. The computer security method for analyzing a plurality of data sets for remediating security incidents in a cloud-based response system as recited in claim 1, further comprises suggesting a set of tasks to a user, wherein the set of tasks includes executing a wizard, evaluating an enrichment to one or more log events, or managing a task using an auto-suggest technique.

5. The computer security method for analyzing a plurality of data sets for remediating security incidents in a cloud-based response system as recited in claim 1, wherein the primary events are presented with a signal that can indicate a vulnerability associated with a computing system of the computer network, a prediction associated with the vulnerability, and a remediation for the vulnerability.

6. The computer security method for analyzing a plurality of data sets for remediating security incidents in a cloud-based response system as recited in claim 5, wherein the signal is generated using natural language processing.

7. The computer security method for analyzing a plurality of data sets for remediating security incidents in a cloud-based response system as recited in claim 1, further comprises identifying risks associated with the computer system, wherein the set of suggested tasks include predefined tasks including installing an anti-virus, disconnecting the unauthorized computing system and/or other remediations in response to the risks.

8-10. (canceled)

11. A non-transitory computer-readable medium comprising instructions that are executable by a processing device for causing the processing device to perform operations comprising:
retrieving logs of data from a computer network;
parsing the logs of data and filtering the logs of data into one or more data sets, wherein the filtering of the logs of data includes:
creating an event timeline of the computer network;
identifying:
known events based on malicious or suspicious indicators on the logs of data,
key events linked to same processes, users, files, network connections as events highlighted by the malicious or the suspicious indicators,
incident events with a time period matching the known events and the key events, and
primary events from the known events, key events, and incident events;
analyzing using a data analysis system, the event timeline of the computer network from the one or more data sets to identify whether data from the logs of data is accessed by an unauthorized computing system, wherein the primary events are associated with the unauthorized computing system; and
generating, based on a result of the identification of whether the data from the logs of data is accessed by the unauthorized computing system, a set of suggested tasks, wherein each suggested task of the set of suggested tasks represents techniques for isolating a host connected to the computer network if the data has been compromised.

12. The non-transitory computer-readable medium comprising instructions that are executable by a processing device for causing the processing device to perform operations as recited in claim 11, further comprising presenting the set of suggested tasks on a user interface.

13. The non-transitory computer-readable medium comprising instructions that are executable by a processing device for causing the processing device to perform operations as recited in claim 11, further comprising identifying risks associated with the computing system, wherein the set of suggested tasks include predefined tasks including installing an anti-virus, disconnecting the unauthorized computing system and/or other remediations in response to the risks.

14. The non-transitory computer-readable medium comprising instructions that are executable by a processing device for causing the processing device to perform operations as recited in claim 11, wherein the primary events are presented with a signal that can indicate a vulnerability associated with a computing system of the computer network, a prediction associated with the vulnerability, and a remediation for the vulnerability.

15. The non-transitory computer-readable medium comprising instructions that are executable by a processing device for causing the processing device to perform operations as recited in claim 14, wherein the signal is generated using natural language processing.

16. A cloud-based response system for analyzing data for remediating security incidents in a cloud environment, comprising:
a data acquisition system configured to:
retrieve logs of data from a computer network;
a data analysis system configured to:
parse the logs of data and filter the logs of data into a plurality of data sets,
wherein the logs of data are filtered by the data analysis system further configured to:
create an event timeline of the computer network;
identify:
known events based on malicious or suspicious indicators on the logs of data,
key events linked to same processes, users, files, network connections as events highlighted by the malicious or the suspicious indicators,
incident events with a time period matching the known events and the key events, and
primary events from the known events, key events, and incident events;
analyze using a data analysis system, the event timeline of the computer network from the plurality of data sets to identify whether data from the logs of data is accessed by an unauthorized computing system, wherein the primary events are associated with the unauthorized computing system; and
an action recommendation system configured to:
generate, based on a result of the identification of whether the data from the logs of data is accessed by the unauthorized computing system, a set of suggested tasks, wherein each suggested task of the set of suggested tasks represents techniques for isolating a host connected to the computer network if the data has been compromised.

17. The cloud-based response system for analyzing data for remediating security incidents in a cloud environment as recited in claim 16, wherein the set of suggested tasks are presented on a user interface.

18. The cloud-based response system for analyzing data for remediating security incidents in a cloud environment as recited in claim 16, wherein the identification that the network has been accessed by the unauthorized computing system includes the computing system modifying, deleting and/or acquiring data to the network without authorization.

19. The cloud-based response system for analyzing data for remediating security incidents in a cloud environment as recited in claim 16, wherein the set of suggested tasks includes executing a wizard, evaluating an enrichment to one or more log events, or managing a task using an auto-suggest technique.

20. The cloud-based response system for analyzing data for remediating security incidents in a cloud environment as recited in claim 16, wherein the primary events are presented with a signal that can indicate a vulnerability associated with a computing system of the computer network, a prediction associated with the vulnerability, and a remediation for the vulnerability.
